(19) United States
(12) Patent Application Publication
(10) Pub. No.: US 2024/0090383 A1
(43) Pub. Date: Mar. 21, 2024

(54) Electric pruning machine

(71) Applicant: Ningbo Yimei Shijia Technology Co., Ltd., Ningbo City (CN)

(72) Inventor: Jianguo Li, Ningbo City (CN)

(21) Appl. No.: 18/456,989

(22) Filed: Aug. 28, 2023

(30) Foreign Application Priority Data
Sep. 16, 2022 (CN) 2022224614611

(51) Int. Cl. A01G 3/025; A01G 3/037

(52) U.S. Cl. CPC A01G 3/0255; A01G 3/037

(57) ABSTRACT

The disclosure provides an electric pruning machine which comprises a fixed blade, a movable blade, and a driving device for driving the movable blade to move towards the fixed blade; an edge portion of the fixed blade is provided with a convex portion protruding from a surface of the edge portion of the fixed blade; and the convex portion is located at a middle position of the edge portion on the fixed blade. Arrangement of the convex portion on the fixed blade can prevent tree branches from being stuck and not moving forward when the fixed blade and the movable blade move relative to each other to shear the tree branches, so as facilitate tree branch pruning and promote shearing of the tree branches.

### TECHNICAL FIELD

The disclosure pertains to the technical field of devices for automatically cutting tree branches, and specifically pertains to an electric pruning machine.

### BACKGROUND

Pruning machines are mainly used for pruning tree branches. However, current electric pruning machines, such as a direct current pruning machine disclosed in Chinese patent publication No. CN2896850Y, an electric pruning machine disclosed in Chinese patent publication No. CN202340486U and a pruning machine disclosed in Chinese patent publication No. CN211671496U, are easy to move forward when cutting thick tree branches, resulting in continuous cutting and getting stuck of the tree branches on the movable blades, and causing disengagement of the tree branches from the movable blades to be very difficult.

### SUMMARY

In order to solve at least one of the technical defects described above, the disclosure provides the following technical solutions.

The present application discloses an electric pruning machine which comprises a fixed blade, a movable blade, and a driving device for driving the movable blade to move towards the fixed blade; an edge portion of the fixed blade is provided with a convex portion protruding from a surface of the edge portion of the fixed blade; and the convex portion is located at a middle position of the edge portion on the fixed blade.

According to the electric pruning machine described above, the electric pruning machine further comprises a fixed blade body located on one side of the movable blade, a working face on the fixed blade body facing the movable blade is flush with an edge portion of the movable blade, or the working face on the fixed blade body facing the movable blade is higher than the edge portion of the movable blade.

According to the electric pruning machine described above, the convex portion and the fixed blade are combined into an integrated structure, or an auxiliary plate is fixed on one side of the fixed blade opposite to the movable blade, and the convex portion is formed on the auxiliary plate.

According to the electric pruning machine described above, the fixed blade body and the fixed blade are combined to form an integrated structure.

According to the electric pruning machine described above, the fixed blade body is fixed on the fixed blade.

According to the electric pruning machine described above, the electric pruning machine further comprises a base shell, and a hinging portion of the fixed blade and a hinging portion pin of the movable blade are hinged to the base shell.

According to the electric pruning machine described above, the electric pruning machine further comprising a base shell, a hinging portion of the fixed blade and a hinging portion pin of the movable blade are hinged to the base shell, and the fixed blade body is fixed between the base shell and the fixed blade.

According to the electric pruning machine described above, the driving device comprises a motor, a reduction gearbox, a toothed disc and a driving gear, the toothed disc is rotatably mounted on the base shell through a rotating shaft, an input shaft of the reduction gearbox is connected to a rotary shaft of the motor, the driving gear is mounted on an output shaft of the reduction gearbox, the rotating shaft of the toothed disc is provided with a driven gear in mesh with oscillating teeth on the movable blade, and the toothed disc meshes with the driving gear.

According to the electric pruning machine described above, a cutting groove is formed between the fixed blade body and the fixed blade.

According to the electric pruning machine described above, the fixed blade body is an arc-shaped blade body, a working face on a side of the arc-shaped blade body facing the fixed blade is an arc-shaped face, and the edge portion of the movable blade is an arc-shaped edge portion.

Compared with the prior art, the electric pruning machine according to the disclosure has the following beneficial effects:

1. Arrangement of the convex portion on the fixed blade can prevent tree branches from being stuck and not moving forward when the fixed blade and the movable blade move relative to each other to shear the tree branches, so as facilitate pruning and promote shearing of the tree branches.

2. The fixed blade body is arranged on one side of the fixed blade, so that when tree branches are stuck on the edge portion of the movable blade, during the process of resetting the movable blade and keeping it away from the fixed blade, the fixed blade body acts on the tree branches, allowing the tree branches to disengage from the edge portion of the movable blade, thus a user can operate the electric pruning machine easily to remove the tree branches stuck on the movable blade, which improves the use effect.

### BRIEF DESCRIPTION OF THE DRAWINGS

In order to illustrate the technical solutions of the embodiments of the disclosure more clearly, the accompanying drawings required for the description of the embodiments will be briefly introduced below. Apparently, the accompanying drawings in the following description are merely some rather than all embodiments of the disclosure, and a person of ordinary skill in the art may still derive other drawings from these accompanying drawings without creative efforts.

FIG. 1 is a schematic view of an overall structure with a base shell removed;

FIG. 2 is a schematic view of an overall structure with a base shell;

FIG. 3 is a schematic view of an overall structure with a base shell and an auxiliary plate;

FIG. 4 is a schematic view of an overall structure in which a convex portion, a fixed blade and a fixed blade body which are combined into an integrated blade structure are mounted;

FIG. 5 is a schematic view of an overall structure in which a fixed blade and a fixed blade body which are combined into an integrated blade structure are mounted, and an auxiliary plate having a convex portion is fixed on the fixed blade;

FIG. 6 is a schematic view of an overall structure in which an auxiliary plate having a convex portion, a fixed blade body and a fixed blade body are split structures; and

FIG. 7 is a schematic view of an overall structure in which a convex portion and a fixed blade are combined into an integrated structure, and a fixed blade body and the fixed blade are split structures.

### DESCRIPTION OF THE EMBODIMENTS

The disclosure will be further described with reference to the accompanying drawings and specific embodiments.

### EMBODIMENTS

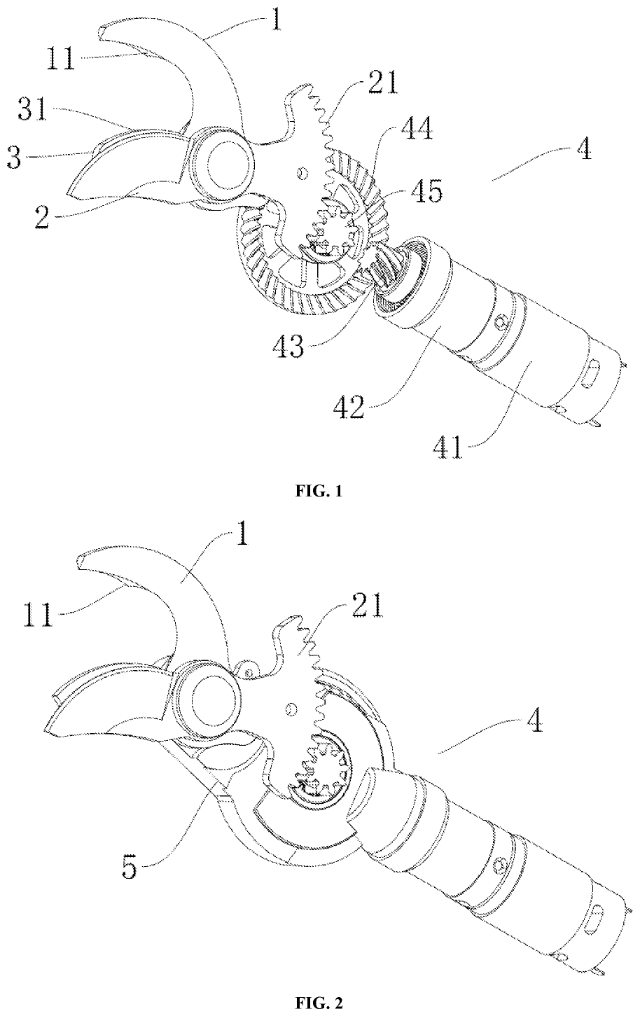

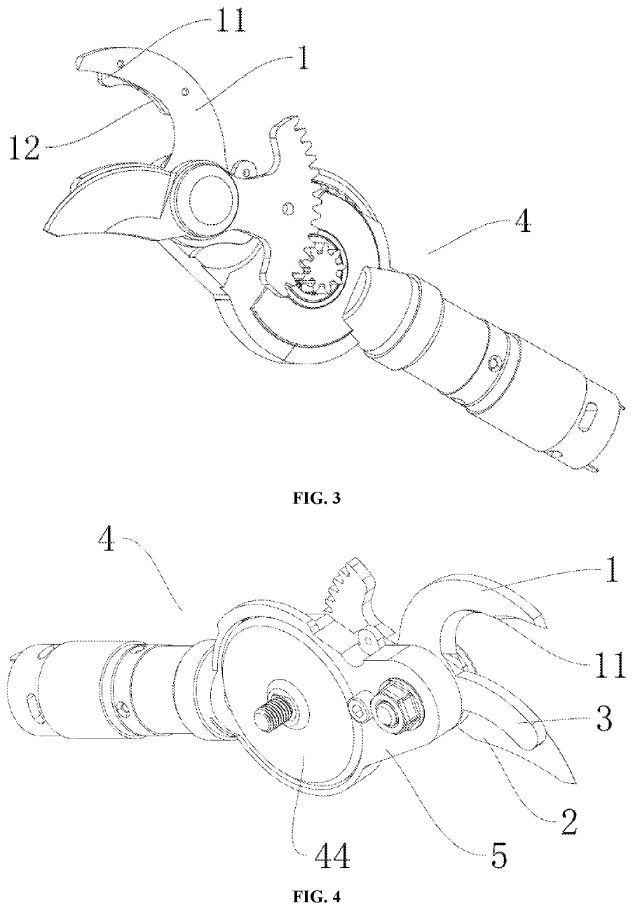

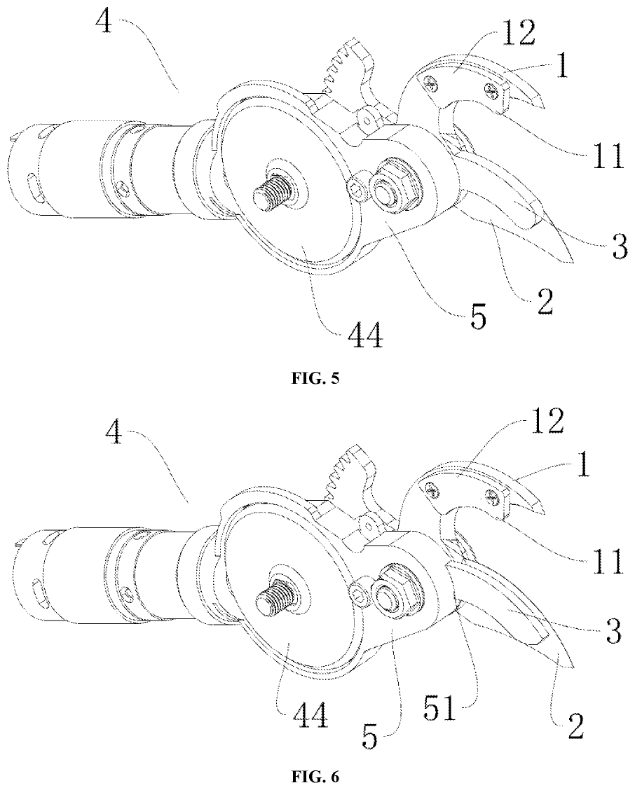

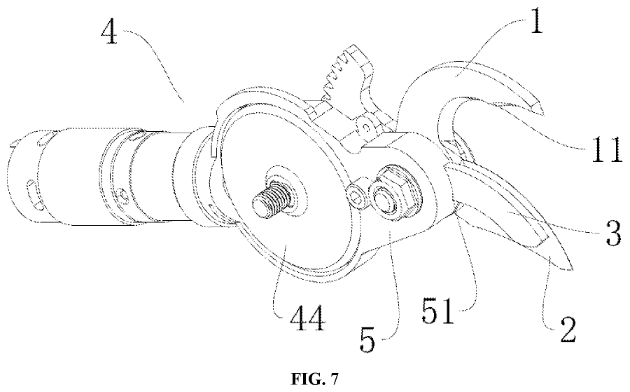

As shown in FIGS. 1-7, an electric pruning machine described in the present embodiment comprises a fixed blade 1, a movable blade 2, and a driving device 4 for driving the movable blade 2 to move to move towards the fixed blade 1; an edge portion of the fixed blade 1 is provided with a convex portion 11 protruding from a surface of the edge portion of the fixed blade 1, and the convex portion 11 is located at a middle position of the edge portion on the fixed blade 1, where the convex portion 11 and the fixed blade 1 are combined into an integrated structure, or an auxiliary plate 12 is fixed on one side of the fixed blade 1 opposite to the movable blade 2 by a bolt, and the convex portion 11 is formed on the auxiliary plate 12; and the auxiliary plate 12, the fixed blade 1 and the movable blade 2 are all made of a metal material.

In the present embodiment, the electric pruning machine further comprises a fixed blade body 3 located on one side of the movable blade 2, a working face 31 on the fixed blade body 3 facing the movable blade 2 is flush with an edge portion of the movable blade 2, or the working face 31 on the fixed blade body 3 facing the movable blade 2 is higher than the edge portion of the movable blade 2, so that the fixed blade body 3 can cause the movable blade 2 to disengage from tree branches stuck on the movable blade 2.

In some preferred embodiments, the fixed blade body 3 and the fixed blade 1 are combined to form an integrated structure, or the fixed blade body 3 is fixed on the fixed blade 1, and the method for arranging the fixed blade body 3 is selected according to the actual situation, and the fixed blade body 3 can be fixed by a bolt or welding.

In the present embodiment, the electric pruning machine further comprises a base shell 5, a hinging portion of the fixed blade 1 and a hinging portion pin of the movable blade 2 are hinged to the base shell 5, where the fixed blade body 3 and the fixed blade 1 are combined into an integrally formed blade, a structure thereof is not limited thereto, and a blade formed by fixing the fixed blade body 3 and the fixed blade 1 to each other can also be selected according to the actual situation.

In some preferred embodiments, when the blade formed by fixing the fixed blade body 3 and the fixed blade 1 to each other is selected, the fixed blade body 3 is fixed between the base shell 5 and the fixed blade 1, and the fixed blade body 3, the base shell 5 and the fixed blade 1 are fixed by bolts, and a lower portion of the fixed blade body 3 is positioned in a positioning groove 51 of the base shell 5.

In the present embodiment, the driving device 4 comprises a motor 41, a reduction gearbox 42, a toothed disc 44 and a driving gear 43, the toothed disc 44 is rotatably mounted on the base shell 5 through a rotating shaft, an input shaft of the reduction gearbox is connected to a rotary shaft of the motor 41, the driving gear 43 is mounted on an output shaft of the reduction gearbox, the rotating shaft of the toothed disc 44 is provided with a driven gear 45 in mesh with oscillating teeth on the movable blade 2, the toothed disc 44 meshes with the driving gear 43, and a gear reduction assembly is provided in the reduction gearbox. During implementation, the motor 41 is powered on to drive the output shaft of the reduction gearbox 42 to rotate forward and backward, thus driving the driving gear 43 to rotate forward and backward; the driving gear 43 drives the toothed disc 44 and the driven gear 45 to rotate forward and backward, thus driving the oscillating teeth to swing left and right, so that the edge portion of the movable blade 2 and the edge portion of the fixed blade 1 approach or move away from each other; when approaching, the tree branches are limited by the convex portion 11, thus preventing the tree branches from moving toward a tip under the action of the movable blade 2 to assist in shearing of the tree branches; and when the tree branches are thick, the tree branches will be stuck on the movable blade 2, the movable blade 2 needs to be reset and move away from the edge portion of the fixed blade 1, and after resetting, the tree branches touch the fixed blade body 3, so that the tree branches are blocked by the fixed blade 1, and the movable blade 2 continues to retreat, causing the tree branches to disengage from the movable blade 2.

In some preferred embodiments, a cutting groove is formed between the fixed blade body 3 and the fixed blade; the fixed blade body 3 is an arc-shaped blade body, a working face 31 on a side of the arc-shaped blade body facing the fixed blade 1 is an arc-shaped face, and the edge portion of the movable blade 2 is an arc-shaped edge portion, which provide a reasonable structural design that facilitates tree branch pruning.

The above are merely preferred embodiments of the disclosure, and are not intended to limit the protection scope of the disclosure, and all technical solutions under the idea of the disclosure fall within the protection scope of the disclosure. It should be noted that a person of ordinary skill in the art may make several improvements or polishing without departing from the principle of the disclosure and the improvements or polishing shall fall within the protection scope of the disclosure.

What is claimed is:

1. An electric pruning machine, comprising a fixed blade (1), a movable blade (2), and a driving device (4) for driving the movable blade (2) to move towards the fixed blade (1), wherein an edge portion of the fixed blade (1) is provided with a convex portion (11) protruding from a surface of the edge portion of the fixed blade (1), and the convex portion (11) is located at a middle position of the edge portion on the fixed blade (1).

2. The electric pruning machine according to claim 1, further comprising a fixed blade body (3) located on one side of the movable blade (2), wherein a working face (31) on the fixed blade body (3) facing the movable blade (2) is flush with an edge portion of the movable blade (2), or the working face (31) on the fixed blade body (3) facing the movable blade (2) is higher than the edge portion of the movable blade (2).

3. The electric pruning machine according to claim 2, wherein the convex portion (11) and the fixed blade (1) are combined into an integrated structure, or an auxiliary plate (12) is fixed on one side of the fixed blade (1) opposite to the movable blade (2), and the convex portion (11) is formed on the auxiliary plate (12).

4. The electric pruning machine according to claim 3, wherein the fixed blade body (3) and the fixed blade (1) are combined to form an integrated structure.

5. The electric pruning machine according to claim 3, wherein the fixed blade body (3) is fixed on the fixed blade (1).

6. The electric pruning machine according to claim 4, further comprising a base shell (5), wherein a hinging portion of the fixed blade (1) and a hinging portion pin of the movable blade (2) are hinged to the base shell (5).

7. The electric pruning machine according to claim 5, further comprising a base shell (5), wherein a hinging portion of the fixed blade (1) and a hinging portion pin of the movable blade (2) are hinged to the base shell (5), and the fixed blade body (3) is fixed between the base shell (5) and the fixed blade (1).

8. The electric pruning machine according to claim 7, wherein the driving device (4) comprises a motor (41), a reduction gearbox (42), a toothed disc (44) and a driving gear (43), the toothed disc (44) is rotatably mounted on the base shell (5) through a rotating shaft, an input shaft of the reduction gearbox is connected to a rotary shaft of the motor (41), the driving gear (43) is mounted on an output shaft of the reduction gearbox, the rotating shaft of the toothed disc (44) is provided with a driven gear (45) in mesh with oscillating teeth on the movable blade (2), and the toothed disc (44) meshes with the driving gear (43).

9. The electric pruning machine according to claim 3, wherein a cutting groove is formed between the fixed blade body (3) and the fixed blade.

10. The electric pruning machine according to claim 9, wherein the fixed blade body (3) is an arc-shaped blade body, a working face (31) on a side of the arc-shaped blade body facing the fixed blade (1) is an arc-shaped face, and the edge portion of the movable blade (2) is an arc-shaped edge portion.
